(19) United States
(12) Patent Application Publication
(10) Pub. No.: US 2016/0333502 A1
(43) Pub. Date: Nov. 17, 2016

(54) FURNACE FOR CONTINUOUSLY GRAPHITIZING CARBON FIBER

(71) Applicants: IHI Corporation, Tokyo (JP); IHI Machinery and Furnace Co., Ltd., Tokyo (JP)

(72) Inventors: Yoshiyasu MATSUDA, Kakamigahara-shi (JP); Atsuo INZEN, Tokyo (JP)

(73) Assignees: IHI Corporation, Tokyo (JP); IHI Machinery and Furnace Co., Ltd., Tokyo (JP)

(21) Appl. No.: 15/221,813

(22) Filed: Jul. 28, 2016

Related U.S. Application Data
(63) Continuation of application No. PCT/JP2015/063187, filed on May 7, 2015.

(30) Foreign Application Priority Data
May 12, 2014 (JP) 2014-099064

(51) Int. Cl. D01F 9/32; F27B 9/02; H05B 3/62; F27B 9/28; F27B 9/36; D01F 9/14; F27B 9/06

(52) U.S. Cl. CPC D01F 9/32; D01F 9/14; F27B 9/02; F27B 9/062; F27B 9/28; F27B 9/36; H05B 3/62

(57) ABSTRACT

A furnace for continuously graphitizing carbon fibers includes a supply unit configured to supply an object to be treated made of carbon fibers, a chamber in which the supplied object to be treated is graphitized, and a recovery unit configured to recover the graphitized object to be treated, in which the chamber includes a preheating zone in which the supplied object to be treated is preheated, and an electric heating zone in which the preheated object to be treated is electrically heated, and the electric heating zone includes a pair of electric rolls across which the preheated object to be treated is strung, and a DC power source that is connected to the pair of electric rolls and applies a current between the pair of electric rolls through the preheated object to be treated that is strung across the pair of electric rolls.

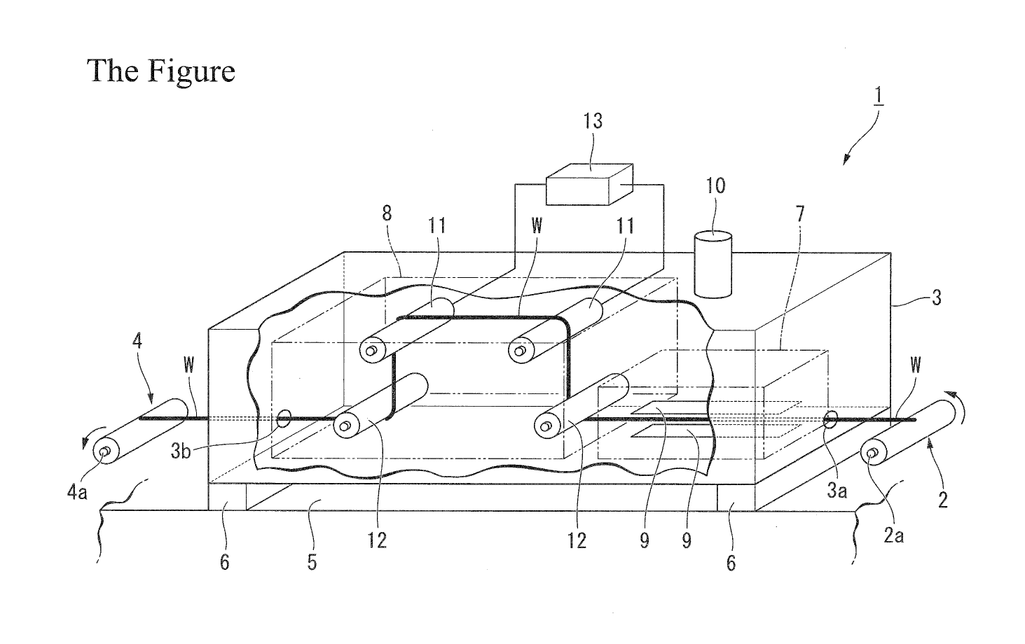

### TECHNICAL FIELD

Embodiments described herein relates to a furnace for continuously graphitizing carbon fibers.

This application is a continuation application based on a PCT Patent Application No. PCT/JP2015/063187, filed on May 7, 2015, whose priority is claimed on Japanese Patent Application No. 2014-099064, filed on May 12, 2014. The contents of both the PCT Application and the Japanese Application are incorporated herein by reference.

### BACKGROUND ART

Graphite has excellent industrial characteristics such as lubricity, conductivity, heat resistance, and chemical resistance, and is used in broad fields such as semiconductor fields, nuclear power fields, and aviation and machinery fields. In general, graphite is produced by heating carbon powder at a high temperature (for example, 2000° C. to 3000° C.) in a graphitization furnace. Meanwhile, a graphitization furnace for graphitizing carbon fibers by heating and calcining is also known (for example, refer to Patent Document 1 and Patent Document 2).

Carbon fibers are formed by calcining through a carbonization treatment. A graphitization furnace for graphitizing carbon fibers is a heating furnace in which carbon fibers is graphitized by heating the carbon fibers at a temperature of about 2000° C. to 3000° C. under an inert atmosphere, thereby obtaining graphitized fibers.

In general, the graphitization furnace heats, calcinates and graphitizes carbon fibers at a temperature of about 2000° C. to 3000° C. using a resistance heater.

### CITATION LIST

Patent Documents

Patent Document 1: Japanese Unexamined Patent Application, First Publication No. 2004-132557

Patent Document 2: Japanese Unexamined Patent Application, First Publication No. 2004-176245

### SUMMARY

When heating is performed at a high temperature, for example, at 2500° C. or more, a resistance heater is severely worn. Accordingly, in a mass production level, there may be a possibility of failure since heating and calcining are continuously performed in a temperature range of 2500° C. or more.

When carbon fibers are graphitized, high elasticity is obtained if heating is performed specifically at 2500° C. or more. In order to obtain high elasticity, it is desirable that heating and calcining are performed at 2500° C. or more, and preferably, at about 2800° C.

The present disclosure has been made in view of the aforementioned problems, and an object of the present disclosure is to provide a furnace for continuously graphitizing carbon fibers that can heat and calcinate at 2500° C. or more while suppressing wear of a resistance heater.

In one aspect of the present disclosure, a furnace for continuously graphitizing carbon fibers that continuously heats, calcinates and graphitizes carbon fibers includes: a supply unit configured to supply the object to be treated made of carbon fibers; a chamber in which the object to be treated supplied from the supply unit is graphitized; and a recovery unit configured to recover the graphitized object to be treated that is discharged from the chamber, in which the chamber includes a preheating zone in which the supplied object to be treated is preheated, and an electric heating zone in which the preheated object to be treated is electrically heated, and the electric heating zone includes a pair of electric rolls, the preheated object to be treated being strung across the pair of electric rolls and traveling between the pair of electric rolls, and a DC power source that is connected to the pair of electric rolls and applies a current between the pair of electric rolls through the preheated object to be treated that is strung across the pair of electric rolls.

According to the furnace for continuously graphitizing carbon fibers of the present disclosure, the chamber includes a preheating zone in which an object to be treated is preheated, and an electric heating zone in which the preheated object to be treated is electrically heated. In the preheating zone, the object to be treated is heated to about 1000° C. by using, for example, a resistance heater. Then, in the electric heating zone, when a current is applied to a pair of electric rolls and the preheated object to be treated that is strung across the pair of electric rolls and travels therebetween, the object to be treated is electrically heated. Therefore, it is possible to calcinate the object to be treated at a high temperature. Accordingly, for example, even when the resistance heater is used in the preheating zone, only heating (preheating) at a relatively low temperature is performed in the preheating zone. Electrical heating is performed in order to perform calcining at a high temperature without using the resistance heater. Therefore, it is possible to perform heating and calcining at 2500° C. or more by electrical heating while suppressing wear of the resistance heater.

### BRIEF DESCRIPTION OF DRAWINGS

The FIGURE is a diagram for describing an embodiment of a furnace for continuously graphitizing carbon fibers of the present disclosure, and is a perspective view schematically showing the furnace for continuously graphitizing carbon fibers.

### DESCRIPTION OF EMBODIMENTS

Hereinafter, a furnace for continuously graphitizing carbon fibers according to the present disclosure will be described in detail with reference to the drawing. Note that, in the following drawing, the scale of members is appropriately changed in order to set the members to a recognizable size.

The FIGURE is a schematic diagram for describing an embodiment of a furnace for continuously graphitizing carbon fibers of the present disclosure. In the FIGURE, reference sign 1 indicates the furnace for continuously graphitizing carbon fibers (hereinafter referred to as a “graphitization furnace”).

The graphitization furnace 1 graphitizes an object to be treated W made of carbon fibers by continuously heating and calcining. The graphitization furnace 1 includes an unwinding unit 2 (a supply unit) configured to unwind and supply the object to be treated W made of carbon fibers, a chamber 3 in which the object to be treated W supplied from the unwinding unit 2 is graphitized, and a winding unit 4 (a recovery unit) configured to wind and recover the graphitized object to be treated W discharged from the chamber 3.

In the unwinding unit 2, the object to be treated W made of carbon fibers is wound on an unwinding roll 2a. When the unwinding roll 2a is rotatably supported by a bearing (not shown), the object to be treated W (carbon fibers) which has been wound on the unwinding roll 2a is continuously unwound. When the object to be treated W is wound and pulled by driving of a driving source such as a motor provided on the winding unit 4 side (to be described below), the unwinding roll 2a also rotates. However, a driving source (not shown) such as a motor may be linked to the unwinding roll 2a of the unwinding unit 2, and the unwinding roll 2a may rotate by the driving of the driving source.

As carbon fibers serving as the object to be treated W, a large number of long carbon fibers (for example, several thousands to tens of thousands) are bundled in a planar form and wound on the unwinding roll 2a. Accordingly, when the object to be treated W is unwound, the large number of carbon fibers, which have been bundled in the planar form, are unwound. However, without such bundling of a large number of carbon fibers, one or several to several hundreds of carbon fibers may be wound in a state where the carbon fibers are disposed side by side in a planar form, and may be unwound in this state.

In addition, the carbon fibers serving as the object to be treated W are not limited to carbon fibers in a fiber state, and woven fabrics obtained by weaving carbon fibers in a sheet form or nonwoven fabrics formed in a sheet form without weaving may be used. That is, a sheet made of carbon fibers may be formed to be elongated and may be used as the object to be treated W. The object to be treated W may be wound on the unwinding roll 2a, and may be unwound during manufacture.

In the FIGURE, in order for other components to be easily visible, a form in which one carbon fiber or a plurality of carbon fibers that are bundled are treated as the object to be treated W is described. However, it is needless to say that a plurality of carbon fibers (for example, several thousands to tens of thousands) or carbon fibers in a sheet form are treated during mass production.

In the chamber 3, the object to be treated W that is unwound and supplied from the unwinding unit 2 is graphitized. The chamber 3 has a rectangular parallelopiped shape having a closed space therein and the closed space serves as a treatment zone.

A floor, a sidewall and a ceiling of the chamber 3 are made of a material having heat resistance and thermal insulation characteristics. Since an electric heating zone (to be described below) inside the chamber 3 is heated to about 1000° C. to 3000° C., a material having heat resistance and thermal insulation characteristics to withstand such a high temperature is used for the chamber 3.

In addition, the chamber 3 is provided to be above an installation surface 5 (a floor) of a room in which the chamber 3 is installed through nonconductive members 6. As the nonconductive member 6, for example, a nonconductive ceramic is used. When the chamber 3 is disposed to be above the installation surface 5 in this manner, it is possible to prevent a leakage from the chamber 3 to the installation surface 5.

In addition, an inlet 3a for introducing the object to be treated W is formed at the sidewall of the chamber 3 on the unwinding unit 2 side, and an outlet 3b for discharging the object to be treated W is formed at the sidewall of the chamber 3 on the winding unit 4 side (to be described below). Both of the inlet 3a and the outlet 3b are air-sealed by air blowing from an air blowing device (not shown) provided at the outside of the sidewall of the chamber 3.

In addition, a nitrogen supply source (not shown) is connected to the chamber 3 through a pipe (not shown). The nitrogen supply source circulates nitrogen inside the chamber 3 and therefore an inside of the chamber 3 has a nitrogen atmosphere. Such a nitrogen atmosphere inside the chamber 3 is favorably maintained since the inlet 3a and the outlet 3b are air-sealed, and therefore most outside air does not flow into the chamber 3.

In addition, a preheating zone 7 and an electric heating zone 8 are provided inside the chamber 3. The preheating zone 7 is a treatment space that is disposed at the unwinding unit 2 side, that is, the inlet 3a side. In the present embodiment, in the preheating zone 7, a pair of resistance heaters 9 and 9 are disposed above and below a traveling path of the object to be treated W to face each other. The resistance heater 9 is a general heater known in the related art, is connected to a power source (not shown), and heats the preheating zone 7 to about 800° C. to 1000° C.

Accordingly, when the object to be treated W traveling through a space between the resistance heaters 9 and 9 in the preheating zone 7 is heated to about 800° C. to 1000° C., carbonization of the object to be treated W resulting from calcining advances. Therefore, a characteristic of the object to be treated W is changed from non-conductivity to conductivity. In such a carbonization treatment according to calcining, an additive that is added to the object to be treated W (carbon fibers) as necessary is decomposed and vaporized. Accordingly, a duct (not shown) is provided at a ceiling side of the preheating zone 7, and a vaporized gas discharge tube 10 communicating with the duct is further provided at the ceiling. Therefore, by heating in the preheating zone 7, the additive added to the object to be treated W (carbon fibers) is decomposed, vaporized, and discharged to the outside of the chamber 3.

Instead of disposing the resistance heaters 9 and 9 above and below the object to be treated W, the resistance heaters 9 and 9 in the preheating zone 7 may be disposed on the right and left sides of the object to be treated W. In addition, the number of resistance heaters 9 is not limited to two, and may be one or three or more.

In the chamber 3, the electric heating zone 8 is disposed downstream relative to the preheating zone 7, that is, at the outlet 3b side. The electric heating zone 8 is a treatment space that communicates with the preheating zone 7. A partition wall (not shown) made of a thermal insulation material may be provided between the preheating zone 7 and the electric heating zone 8 as necessary. However, needless to say that, when the partition wall is provided, a through-hole through which the object to be treated W travels is formed in the partition wall.

In the electric heating zone 8, a pair of electric rolls 11 and 11 and a pair of tension rolls 12 and 12 are provided. The electric rolls 11 and 11 are disposed in parallel to each other at a predetermined interval, and are rotatably provided by a bearing (not shown). The preheated object to be treated W is strung across and travels between the electric rolls 11 and 11. As will be described below, the electric rolls 11 and 11 have conductivity and heat resistance to withstand about 3000° C. such that the object to be treated W is heated by electrical heating to a temperature of 1000° C. to 3000° C., and particularly, to about 2500° C. to 3000° C. which is a temperature at which high elasticity can be provided according to graphitization, and preferably to about 2800° C. to 3000° C. The electric rolls 11 and 11 are made of, for example, graphite.

A direct current (DC) power source 13 is connected to the electric rolls 11 and 11 through a wire (not shown). Here, since the electric rolls 11 and 11 are not directly in contact with each other, during a non-treatment time, a current does not flow between the electric rolls 11 and 11 even when the DC power source 13 is turned on. On the other hand, when the preheated object to be treated W is strung across the electric rolls 11 and 11 during a treatment time, since the object to be treated W obtains conductivity by the preheating, a current flows between the electric rolls 11 and 11 through the object to be treated W. Accordingly, the object to be treated W is electrically heated.

A control unit (not shown) is provided in the DC power source 13. By controlling the control unit, it is possible to flow a current having a desired magnitude between the electric rolls 11 and 11. That is, a desired current flows in the object to be treated W strung across the electric rolls 11 and 11, and the object to be treated W can be electrically heated to a desired temperature. When a correlation between a value of a current flowing in the object to be treated W and a heating temperature of the object to be treated W by electrical heating is obtained in advance, it is possible to appropriately control an electrical heating temperature of the object to be treated W by the control unit of the DC power source 13.

The tension rolls 12 and 12 are provided upstream and downstream relative to the pair of electric rolls 11 and 11 in a state where the tension rolls 12 and 12 are positioned below the electric rolls 11 and 11. The tension rolls 12 and 12 are disposed in parallel at a predetermined interval with respect to the adjacent electric rolls 11, and are rotatably provided by a bearing (not shown). In addition, the tension rolls 12 and 12 have heat resistance to withstand about 3000° C. since heating is performed to about 2800° C. to 3000° C. between the electric rolls 11 and 11. The tension rolls 12 and 12 are made of, for example, graphite.

The upstream-side tension roll 12 changes a traveling direction of the object to be treated W that has traveled in a horizontal direction from the preheating zone 7 to an upper direction and provides a tension to the object to be treated W. The downstream-side tension roll 12 changes a traveling direction of the object to be treated W that has traveled downward from the downstream-side electric roll 11 to the horizontal direction and provides a tension to the object to be treated W.

Here, a tension maintenance mechanism (not shown) is provided at, for example, bearings of the tension rolls 12 and 12. The tension maintenance mechanism corrects a tension of the object to be treated W that travels between the tension roll 12 and the electric roll 11, for example, by ascending or descending the tension roll 12, and thereby the tension of the object to be treated W that travels between the electric rolls 11 and 11 is adjusted to a preset tension.

Accordingly, the object to be treated W travels between the electric rolls 11 and 11 while maintaining a predetermined appropriate tension that is provided by the upstream-side tension roll 12 and the downstream-side tension roll 12 without bending.

That is, even when the object to be treated W is expanded or contracted due to calcining through electrical heating, a tension of the object to be treated W remains at the preset tension by the tension maintenance mechanism.

On the downstream-side tension roll 12 side, the outlet 3b is formed at the sidewall of the chamber 3. The winding unit 4 is provided at the outside of the outlet 3b (the outside of the chamber 3). The winding unit 4 winds the electrically-heated (graphitized) object to be treated W and recovers the object to be treated W using a winding roll 4a. That is, the winding roll 4a is rotatably supported by a bearing (not shown), and linked to the driving source such as a motor. When the driving source is driven to rotate the winding roll 4a, it is possible to wind and recover the object to be treated W. In addition, by winding the object to be treated W in this manner, the object to be treated W is unwound from the unwinding unit 2, and travels through the preheating zone 7 and the electric heating zone 8.

The winding roll 4a is made of a nonconductive and heat-resistant material, for example, a nonconductive ceramic. Therefore, it is possible to prevent a leakage from the electric roll 11 side and to wind the electrically heated object to be treated W having a relatively high temperature without any problem.

When the object to be treated W is graphitized in the graphitization furnace 1 having such a configuration, first, the object to be treated W is set. That is, the object to be treated W is wound on the unwinding roll 2a of the unwinding unit 2. One end side of the object to be treated W is input into the chamber 3 from the inlet 3a, passes between the resistance heaters 9 and 9 that are disposed to face each other, and further extends to the electric heating zone 8. In the electric heating zone 8, the object to be treated W is drawn to the upstream-side tension roll 12, is then strung across the pair of electric rolls 11 and 11, and is further drawn to the downstream-side tension roll 12. Then, the object to be treated W is dragged from the outlet 3b and wound on the winding roll 4a.

After setting the object to be treated W in this manner, power is supplied to the resistance heaters 9 and 9 in the preheating zone 7 to heat the object to be treated W, power is supplied to the electric rolls 11 and 11, the driving source of the winding unit 4 is driven to wind the object to be treated W on the winding unit 4.

In this manner, when the object to be treated W is wound on the winding unit 4, the object to be treated W continuously travels and is unwound from the unwinding unit 2. The object to be treated W is unwound from the unwinding unit 2, is introduced into the chamber 3 through the inlet 3a, and passes between the resistance heaters 9 and 9 that face each other in the preheating zone 7 to be preheated to about 800° C. to 1000° C. As a result, the object to be treated W is heated as described above and has conductivity as carbonization is advanced by calcining.

Further, after the tension is provided by the upstream-side tension roll 12, the traveling direction of the preheated object to be treated W is changed, and the preheated object to be treated W travels between the electric rolls 11 and 11 while strung thereacross. Since the preheated object to be treated W has conductivity, the current flows between the electric rolls 11 and 11 through the object to be treated W, and the current also flows in the object to be treated W. Therefore, the object to be treated W is electrically heated, calcinated at a preset temperature, and graphitized.

The traveling direction of the graphitized object to be treated W is changed by the downstream-side tension roll 12, and the graphitized object to be treated W is discharged from the outlet 3b and is then wound on the winding unit 4.

In the graphitization furnace 1 of the present embodiment, the chamber 3 includes the preheating zone 7 in which the object to be treated W is preheated, and the electric heating zone 8 in which the preheated object to be treated W is electrically heated. In the preheating zone 7, the object to be treated is heated to about 800° C. to 1000° C. by the resistance heater 9 to provide conductivity. Then, in the electric heating zone 8, a current is applied to the pair of electric rolls 11 and 11 and the preheated object to be treated W that is strung thereacross and travels therebetween, and the object to be treated W is electrically heated. As a result, it is possible to calcinate the object to be treated W at a high temperature, for example, at about 2800° C. to 3000° C.

Accordingly, although the resistance heater 9 is used, only heating (preheating) at a relatively low temperature is performed in the preheating zone in which the resistance heater 9 is used. In order to perform calcining at a high temperature, electrical heating is performed without using the resistance heater. Therefore, even in the manufacture at a mass production level, it is possible to suppress wear of the resistance heater 9. In addition, since heating and calcining can be performed at a high temperature, for example, at 2800° C. or more, by electrical heating, it is possible to provide high elasticity to the obtained graphitized carbon fibers.

In addition, since the tension rolls 12 are provided upstream and downstream relative to the pair of electric rolls 11 and 11, it is possible to provide an appropriate tension to the object to be treated W that travels between the pair of electric rolls 11 and 11 by the tension rolls 12 and 12. Therefore, even when the object to be treated W is expanded or contracted due to calcining through electrical heating, the object to be treated W can travel between the electric rolls 11 and 11 at an appropriate tension without bending and without excessive pulling between the electric rolls 11 and 11.

Accordingly, it is possible to stably flow a constant current between the electric rolls 11 and 11 through the object to be treated W. Therefore, the constant current also flows in the object to be treated W, and electrical heating can be performed at a constant temperature. Accordingly, it is possible to stabilize quality of the obtained graphitized carbon fibers.

In addition, since the chamber 3 is provided to be above the installation surface 5 through the nonconductive members 6, it is possible to prevent a leakage from the chamber 3 to the installation surface 5. Further, since the winding roll 4a of the winding unit 4 has non-conductivity, it is possible to prevent a leakage from the electric roll 11 side to the winding unit 4 through the object to be treated W.

In addition, since the pair of electric rolls 11 and 11 are used as an electrical heating unit, it is possible to downsize a device configuration of the electrical heating unit and accordingly downsize the chamber 3. In addition, since carbon fibers can be continuously graphitized, it is possible to increase production efficiency.

In addition, although not shown, as described above, carbon fibers formed in a long sheet form may be used as the object to be treated W, and the object to be treated W in a sheet form may be continuously graphitized. Accordingly, the object to be treated W having any form, for example, a fiber form or a sheet form, can be continuously graphitized in the same graphitization furnace 1. Compared to when the object to be treated W in a fiber form and the object to be treated W in a sheet form are treated in separate graphitization furnaces, it is possible to significantly reduce a facility cost and a running cost.

The present disclosure is not limited to the embodiment, and various modifications can be made without departing from the spirit and scope of the present disclosure.

For example, while the electric rolls 11 and 11 are provided above the pair of tension rolls 12 and 12 in the embodiment, a disposition of the tension rolls 12 and the electric rolls 11 may be appropriately changed depending on a shape, a size or the like of the chamber 3.

### INDUSTRIAL APPLICABILITY

According to the present disclosure, it is possible to provide a furnace for continuously graphitizing carbon fibers that can heat and calcinate at 2500° C. or more while suppressing wear of a resistance heater.

What is claimed is:

1. A furnace for continuously graphitizing carbon fibers that continuously heats, calcinates and graphitizes an object to be treated made of carbon fibers, the furnace for continuously graphitizing carbon fibers comprising:
a supply unit configured to supply the object to be treated made of carbon fibers;
a chamber in which the object to be treated supplied from the supply unit is graphitized; and
a recovery unit configured to recover the graphitized object to be treated that is discharged from the chamber,
wherein the chamber includes a preheating zone in which the supplied object to be treated is preheated, and an electric heating zone in which the preheated object to be treated is electrically heated, and
wherein the electric heating zone includes a pair of electric rolls, the preheated object to be treated being strung across the pair of electric rolls and traveling between the pair of electric rolls, and a DC power source that is connected to the pair of electric rolls and applies a current between the pair of electric rolls through the preheated object to be treated that is strung across the pair of electric rolls.

2. The furnace for continuously graphitizing carbon fibers according to claim 1,
wherein the electric heating zone further includes a pair of tension rolls that are provided upstream and downstream relative to the pair of electric rolls and provide a tension to the object to be treated that travels between the pair of electric rolls.

3. The furnace for continuously graphitizing carbon fibers according to claim 1,
wherein the chamber is provided to be above an installation surface through a nonconductive member, and
wherein the recovery unit includes a nonconductive winding roll on which the graphitized object to be treated is wound, the object to be treated being recovered by winding the graphitized object to be treated using the winding roll.

4. The furnace for continuously graphitizing carbon fibers according to claim 2,
wherein the chamber is provided to be above an installation surface through a nonconductive member, and
wherein the recovery unit includes a nonconductive winding roll on which the graphitized object to be treated is wound, the object to be treated being recovered by winding the graphitized object to be treated using the winding roll.

5. The furnace for continuously graphitizing carbon fibers according to claim 1,
wherein the object to be treated is preheated at 800° C. to 1000° C. in the preheating zone, and
wherein the object to be treated is electrically heated at 1000° C. to 3000° C. in the electric heating zone.
